(19) United States
(12) Patent Application Publication
(10) Pub. No.: US 2022/0323891 A1
(43) Pub. Date: Oct. 13, 2022

(54) VARIABLE-ANGLE BAFFLE ARRANGEMENT FOR AIR-LIQUID SEPARATION

(71) Applicant: CUMMINS FILTRATION IP, INC., Columbus, IN (US)

(72) Inventors: Vijay Dinkar Kolhe, Nashik (IN); Navin Sunana, Rajnandgaon, CG (IN); Peter K. Herman, Stoughton, WI (US); Benjamin L. Scheckel, Stoughton, WI (US); Janhavi C. Fadnavis, Nagpur (IN)

(73) Assignee: CUMMINS FILTRATION IP, INC., Columbus, IN (US)

(21) Appl. No.: 17/619,832

(22) PCT Filed: Jun. 26, 2020
(86) PCT No.: PCT/US2020/039757

§ 371 Date: Dec. 16, 2021

Related U.S. Application Data
(60) Provisional application No. 62/869,120, filed on Jul. 1, 2019.

(51) Int. Cl. B01D 45/08

(52) U.S. Cl. CPC B01D 45/08; F01M 13/04

(57) ABSTRACT

An air-liquid separation assembly for separating air and liquid from an air-liquid mixture comprises a housing through which fluid flows, a main separator positioned within the housing, and a sub-separator. The sub-separator is positioned within the housing before or after the main separator and defines a plurality of slots. Each of the plurality of slots is positioned either between adjacent baffles of the sub-separator or between a baffle of the sub-separator and a portion of the housing. The plurality of slots are positioned next to each other in a direction substantially perpendicular to the direction of fluid flow through the housing. The plurality of slots comprises a first subset of slots and a second subset of slots. The second subset of slots extends at a different angle than the first subset of slots such that fluid flows through the first subset of slots and the second subset of slots at different angles.

### CROSS-REFERENCE TO RELATED PATENT APPLICATIONS

This application claims priority to and the benefit of U.S. Provisional Patent Application No. 62/869,120, filed Jul. 1, 2019 and the contents of which are incorporated herein by reference in their entirety.

### FIELD

The present invention relates generally to air-liquid separation assemblies, such as air-oil separation assemblies.

### BACKGROUND

Air-oil separation assemblies often have a main separator (i.e., a standard or variable impactor) and a sub-separator (i.e., a pre-separator or a post-separator). The sub-separator, in particular a pre-separator, removes coarser oil particles from the air. If the sub-separator is a pre-separator, the sub-separator thus helps reduce the load on the main separator, improves the overall oil separation efficiency, and increases the life of the main separator. If the sub-separator is a post-separator, the sub-separator directs the flow of fluid after the main separator.

As shown in FIGS. 1 and 2A, a conventional air-liquid separation assembly 120 includes a main separator 110 (as shown in FIG. 2A) and a sub-separator 130 with a baffle arrangement of a plurality of baffles 140 in order to help separate the oil from the air and to direct the flow of fluid (in particular after the main separator). (Other conventional sub-separators 130 utilize louvers or a labyrinth.) A plurality of flow passages or slots 160 are defined between each of the baffles 140 and are positioned at the same angle relative to each other.

However, as shown in the flow model of velocity vectors in FIG. 2B, flow recirculation on the downstream side of the plurality of baffles 140 occurs, which implies an ineffective utilization of the available flow area or volume within the conventional air-liquid separation assembly 120. Furthermore, the downstream flow distribution of the sub-separators 130 is not uniform, which would be aggravated if there is an immediate change in flow direction on the downstream side of the sub-separator 130.

FIGS. 3A-3B and FIG. 4 each show other conventional sub-separators 130 with a plurality of baffles 140 (from U.S. Patent Application Publication Nos. 2012/0297980 and 2016/0032819, respectively, the entire disclosures of which are incorporated by reference herein in their entirety). In FIGS. 3A-3B, the plurality of baffles 140 defines a plurality of slots 160 that are separate flow paths in parallel with each other, all oriented at the same angle relative to each other. The baffles 140 each have hooks that direct that fluid flow away from the separated oil. In particular, the baffles 140 help collect and drain the separated oil using a trough within the housing. However, the baffles 140 occupy a relatively large amount of space as shown in the ratio of the length of the hook to the rest of the baffle.

In FIG. 4, the plurality of baffles 140 have a staggered or stacked arrangement and define a slot 160 forming one flow path (i.e., the fluid flows in series along each of the baffles 140). The baffles 140 of FIG. 4 cause a relatively high amount of flow separation due to the sudden change in flow direction at multiple points, which causes a high pressure drop. Furthermore, the baffles 140 also occupy a relatively large amount of space.

### SUMMARY

Various embodiments provide for an air-liquid separation assembly for separating air and liquid from an air-liquid mixture comprising a housing through which fluid flows, a main separator positioned within the housing, and a sub-separator. The sub-separator is positioned within the housing before or after the main separator and defines a plurality of slots. Each of the plurality of slots is positioned either between adjacent baffles of the sub-separator or between a baffle of the sub-separator and a portion of the housing. The plurality of slots are positioned next to each other in a direction substantially perpendicular to the direction of fluid flow through the housing such that each portion of the fluid flow flows through only one of the plurality of slots. The plurality of slots comprises a first subset of slots and a second subset of slots. The second subset of slots extends at a different angle than the first subset of slots such that fluid flows through the first subset of slots and the second subset of slots at different angles.

Various other embodiments provide for an air-liquid separation assembly for separating air and liquid from an air-liquid mixture comprising a housing through which fluid flows and a sub-separator. The sub-separator is positioned within the housing and defines a plurality of slots positioned next to each other in a direction substantially perpendicular to the direction of fluid flow through the housing such that each portion of the fluid flow flows through only one of the plurality of slots. The plurality of slots comprises a first subset of slots and a second subset of slots. The second subset of slots extends at a different angle than the first subset of slots such that fluid flows through the first subset of slots and the second subset of slots at different angles.

These and other features (including, but not limited to, retaining features and/or viewing features), together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a top view of a portion of a conventional air-liquid separation assembly.

FIG. 2A is a top view of a conventional air-liquid separation assembly.

FIG. 2B is a flow model of velocity vectors through the conventional air-liquid separation assembly of FIG. 2A.

FIG. 3A is a plan view of a conventional air-liquid separation assembly.

FIG. 3B is an exploded, perspective view of the conventional air-liquid separation assembly of FIG. 3A.

FIG. 4 is a plan view of a conventional air-liquid separation assembly.

FIG. 5A is a top view of an air-liquid separation assembly according to one embodiment.

FIG. 5B is a flow model of velocity vectors through the air-liquid separation assembly of FIG. 5A.

FIG. 6A is a perspective view of an air-liquid separation assembly according to another embodiment.

FIG. 6B is a top view of a portion of the air-liquid separation assembly of FIG. 6A.

FIG. 6C is a flow model of velocity vectors through the air-liquid separation assembly of FIG. 6A.

FIG. 7 is a flow model of velocity vectors through a conventional air-liquid separation assembly.

FIG. 8 is a top view of an air-liquid separation assembly according to yet another embodiment.

FIG. 9 is a top view (and partially-expanded view) of the air-liquid separation assembly of FIG. 8.

FIG. 10 is a top view of an air-liquid separation assembly according to another embodiment.

FIG. 11 is a top view of an air-liquid separation assembly according to yet another embodiment.

FIG. 12 is a top view of an air-liquid separation assembly according to still another embodiment.

FIG. 13 is a top view of an air-liquid separation assembly according to another embodiment.

FIG. 14 is a top view of an air-liquid separation assembly according to yet another embodiment.

FIG. 15 is a top view of various baffles according to various embodiments of the air-liquid separation assemblies.

FIG. 16 is a top view of an air-liquid separation assembly according to yet another embodiment.

FIG. 17 is a top view of an air-liquid separation assembly according to still another embodiment.

FIG. 18 is a top view of an air-liquid separation assembly according to another embodiment.

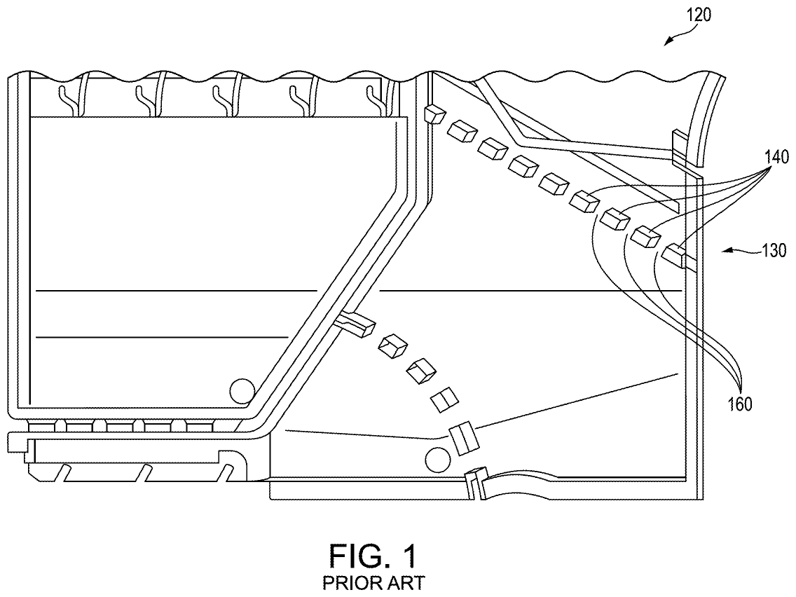

### DETAILED DESCRIPTION

Referring to the figures generally, various embodiments disclosed herein relate to an air-liquid separation assembly for separating air and liquid from a fluid, such as an air-liquid mixture. As described further herein, the air-liquid separation assembly comprises a main separator and a sub-separator. The sub-separator comprises a plurality of baffles defining a plurality of slots that direct portions of the fluid in different angles relative to each other.

The particular configuration of the sub-separator (as described further herein) improves the performance and cost effectiveness of the air-liquid separation assembly by improving several different aspects of the air-liquid separation assembly. For example, the particular configuration of the sub-separator allows the sub-separator to effectively act as a pre- or post-separator in a limited space by improving liquid separation from the air and helping separate larger liquid particles from the air. Additionally, the particular configuration of the sub-separator modifies the flow field and more uniformly distributes the flow downstream from the sub-separator, thereby obtaining and maintaining a desired and improved downstream flow distribution and utilizing the space (i.e. the available flow area or volume) within the air-liquid separation assembly better. Even further, the particular configuration of the sub-separator changes the downstream trajectory of the liquid particles in order to slow down the fluid flow downstream of the sub-separator, increase residence time, and even out the fluid flow prior to the expansion zone. Accordingly, any re-entrainment and carry-over of regenerated liquid particles is reduced or prevented (compared to conventional baffle, labyrinth, or louver systems in conventional sub-separators 130).

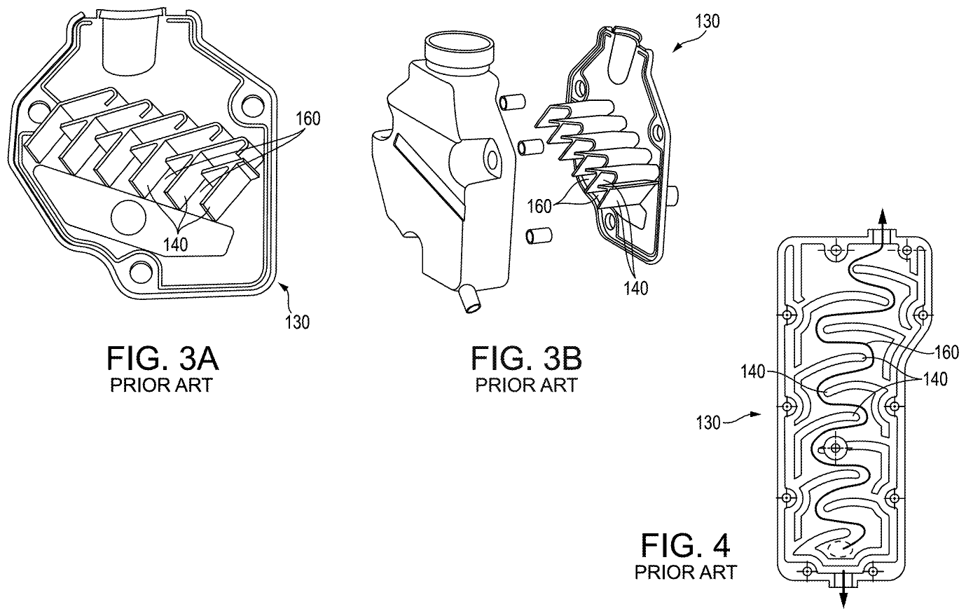

As a pre-separator, the sub-separator according to the embodiments described herein is particularly beneficial in air-liquid separation assemblies that only have a small or limited amount of space available for air-liquid separation, and therefore enhancing pre-separation is particularly important. Alternatively, as a post-separator, the sub-separator is particularly beneficial in directing fluid flow after the main separator. The sub-separator occupies much less space (in particular compared to the conventional sub-separators 130 shown in FIGS. 3A-4) while still improving air-liquid separation.

### Air-Liquid Separation Assembly

The air-liquid separation assembly 20 is configured to separate liquid and air from a fluid, such as an air-liquid mixture, and may be, for example, a crankcase ventilation (CV) product or part of an air intake system for a turbine. According to one embodiment, the air-liquid separation assembly 20 may be an air-oil separation assembly that is configured to separate oil from air. Accordingly, the liquid and liquid particles referred to herein may be, for example, oil or oil particles. The air-liquid separation assembly 20 may be used within a diesel engine, for example.

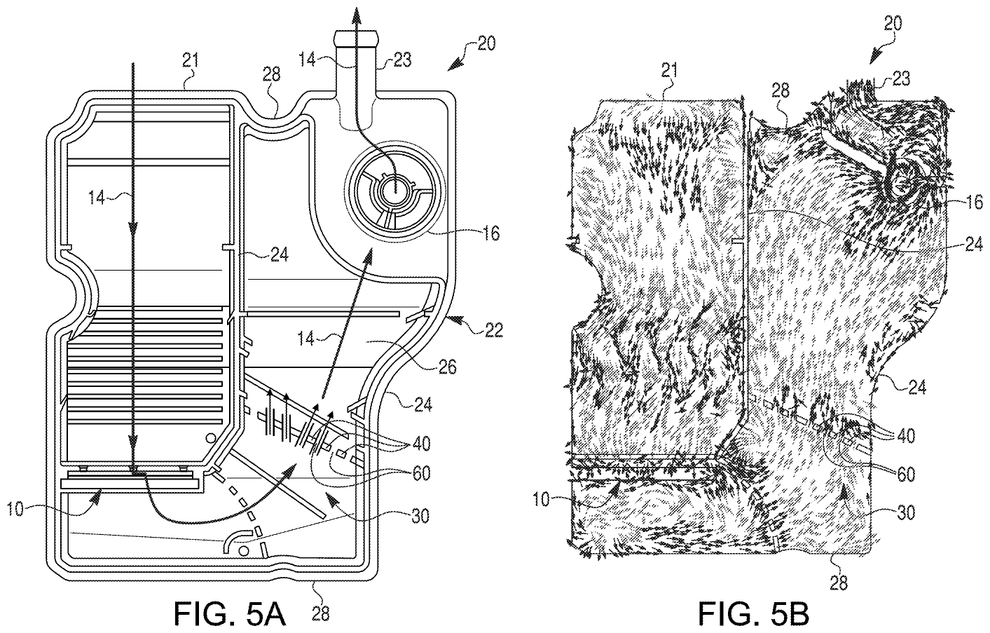

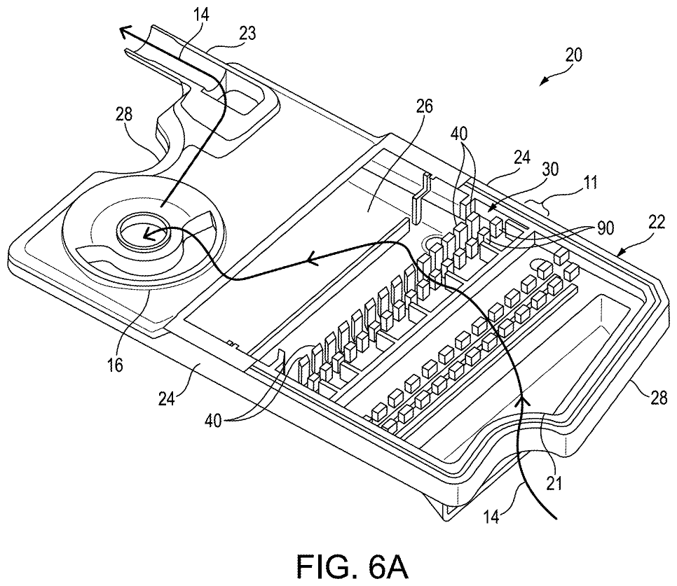

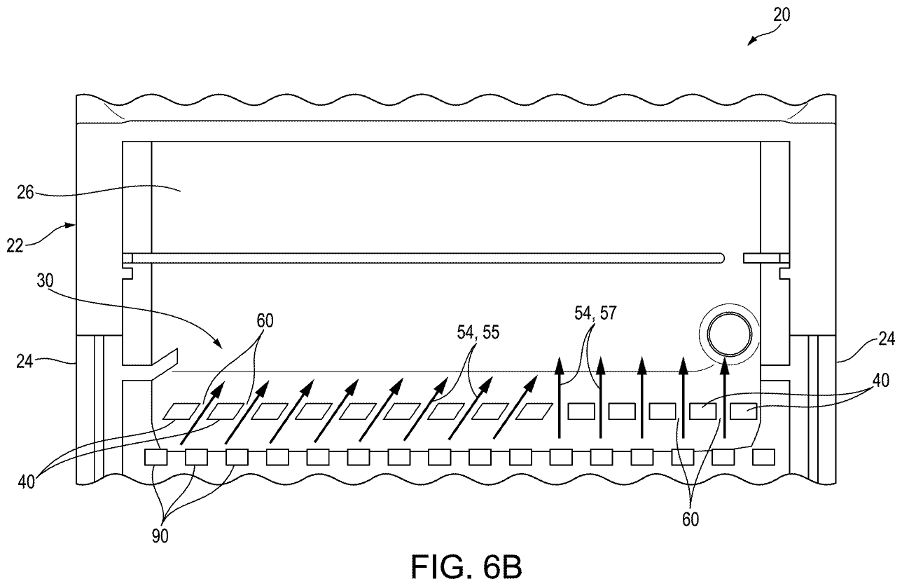

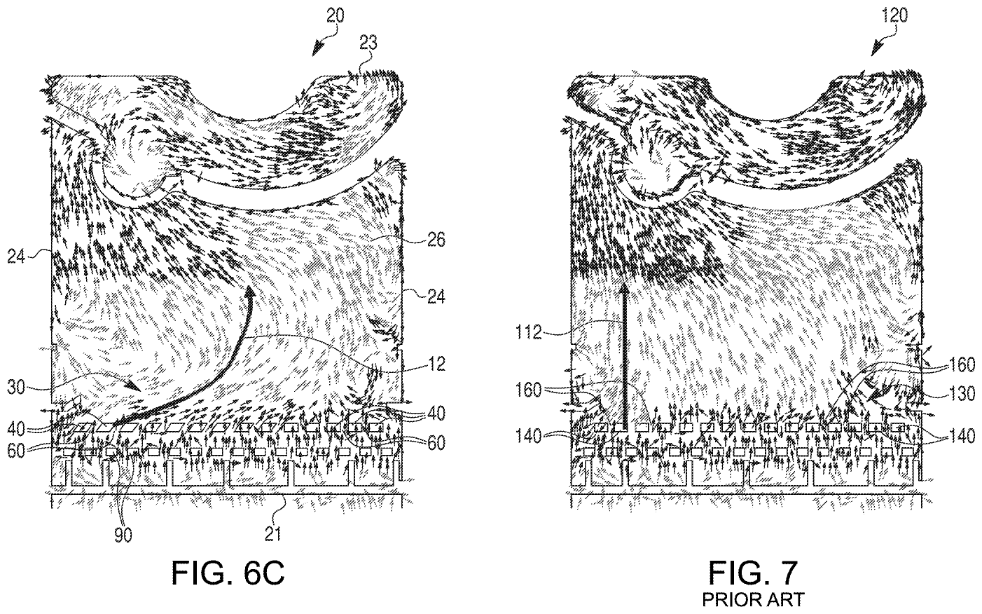

As shown in FIG. 5A and FIG. 6A, for example, the air-liquid separation assembly 20 comprises a housing 22 through which the air-liquid mixture flows and that comprises an inlet 21 (configured to receive a fluid (i.e., the air-liquid mixture) to be separated) and an outlet 23 (configured to release the separated fluid (i.e., the air without the liquid)). The housing 22 defines an inner area that allows fluid to flow from the inlet 21 to the outlet 23. The main separator 10 and the sub-separator 30 (as described further herein) are positioned within the housing 22, between the inlet 21 and the outlet 23 along the direction of fluid flow through the housing 22. At least the sub-separator 30 is positioned within this inner area of the housing 22. An exemplary fluid flow path 14 is shown which flows into the housing 22 through the inlet 21, through (or onto) the main separator 10, through the sub-separator 30, and subsequently out of the housing 22 through the outlet 23. The air-liquid separator assembly 20 may further comprise a valve 16 (such as a crankcase depression regulator (CDR) valve) in order to maintain the crankcase pressure in a desired range.

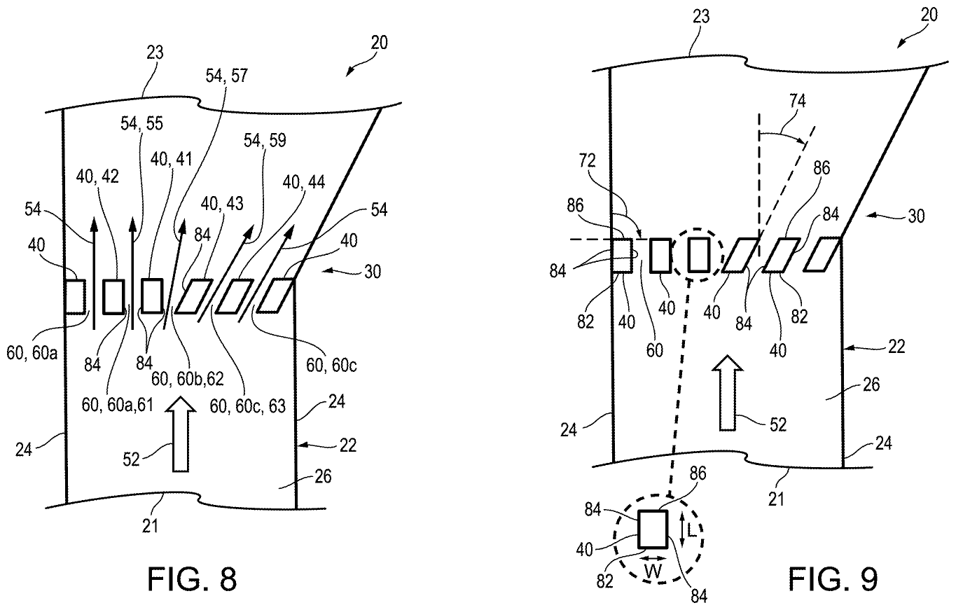

The housing 22 also comprises at least two housing side walls 24, two housing main walls 26 (e.g., a top wall and a bottom wall), and two housing end walls 28 so as to define the inner area of the housing 22. Each of the side walls 24, main walls 26, and end walls 28 may be external or internal walls of the housing 22. One of the side walls 24 may be, for example, a CV internal wall. The side walls 24 and the main walls 26 extend along the entire length of the housing 22 in the fluid flow direction from the inlet 21 to the outlet 23, thereby helping direct the flow of fluid from the inlet 21 to the outlet 23. The two end walls 28 are positioned along respective inlet and outlet ends of the housing 22 and are substantially perpendicular to the direction of fluid flow from the inlet 21 to the outlet 23. The two housing side walls 24, the two housing end walls 28, and the two housing main walls 26 may be approximately perpendicular to each other. The two housing side walls 24 directly oppose each other (and positioned along opposite sides of the housing 22) and at least portions of the two housing side walls 24 may be parallel to each other, the two housing main walls 26 (i.e., the top and bottom walls) directly oppose each other (and positioned along opposite sides of the housing 22) and may be parallel to each other, and the two housing end walls 28 directly oppose each other (and positioned along opposite sides of the housing 22) and may be parallel to each other. However, as shown in FIG. 8, only a portion of the two housing side walls 24 are parallel to each other. In particular, the portions of the two housing side walls 24 that are upstream from and aligned with the sub-separator 30 are parallel. The portions of the two housing side walls 24 that are downstream from the sub-separator 30 are not parallel (i.e., one of the housing side walls 24 angles away from the other housing side wall 24, thereby providing additional area for the fluid to flow into after flowing through the sub-separator 30).

As shown in FIG. 5A, the air-liquid separation assembly 20 comprises a main separator 10 and a sub-separator 30 (as described further herein) positioned within the housing 22. The main separation device or separator 10 may be, for example, a standard or variable impactor or a coalescer that separates out the liquid from the air. As shown in FIG. 5A, the main separator 10 is positioned before the sub-separator 30 along the direction of fluid flow. However, in other embodiments, it is understood that the main separator 10 may be positioned after the sub-separator 30 along the direction of fluid flow.

### Sub-Separator

The sub-separation device or separator 30 comprises a variable-angle baffle arrangement (as described further herein) in order to direct the fluid flow (before or after the main separator 10), separate out liquid from air, provide the desired downstream flow distribution, and prevent liquid carry-over into the separated air, as described further herein. Accordingly, the sub-separator 30 increases efficiency of the air-liquid separation assembly 20 as a whole.

The sub-separator 30 may be positioned before the main separator 10 as a pre-separator or after the main separator 10 as a post-separator (as shown in FIG. 5A, for example) along the direction of fluid flow along the flow path 14. When the sub-separator 30 is positioned as a pre-separator, the sub-separator 30 helps pre-separate the liquid from the air, uniformly distributes the fluid flow, reduces the load on the main separator 10, and increases the efficiency of the main separator 10. When the sub-separator 30 is positioned as a post-separator, the sub-separator 30 can also be a line of site baffle by preventing the liquid particles from directly escaping to the outlet 23 of the housing 22 and distributing the flow better.

Accordingly, as shown in FIG. 8, in order to be an effective sub-separator 30 and to distribute the fluid flow more evenly, the sub-separator 30 comprises a variable-angle baffle arrangement that comprises at least one baffle (e.g., a first baffle 41) and defines a plurality of slots 60. In particular, the plurality of baffles 40 (or just the first baffle 41) defines at least two slots or a plurality of slots 60 (e.g., a first slot 61 and a second slot 62) such that each of the plurality of slots 60 is positioned either between adjacent baffles 40 of the sub-separator 30 (e.g., the first baffle 41 and another baffle 40, such as the second baffle 42 or the third baffle 43) or between a baffle 40 (e.g., the first baffle 41) and a portion (i.e., the side wall 24) of the housing 22. In particular, the sub-separator 30 comprises a first plurality of posts or baffles 40 (comprising the first baffle 41) defining a plurality of fluid flow passages, channels, or slots 60 (comprising the first slot 61 and the second slot 62) positioned between the baffles 40 and/or the side walls 24 of the housing 22, as described further herein. The plurality of baffles 40 force the fluid to flow through the plurality of slots 60 in order to flow from the upstream side to the downstream side of the sub-separator 30.

By helping further separate liquid from air, the sub-separator 30 improves the liquid separation from the air. In order to help further separate liquid out from the air (i.e., pre- or post-separation), the sub-separator 30 causes the fluid (i.e., the air-liquid mixture) flowing into the plurality of slots 60 from the upstream side of the sub-separator 30 to suddenly change direction when the fluid passes through the slots 60. Since liquid (e.g., oil) has a higher density compared to air, liquid has more inertia than air, and therefore the liquid particles impinge on and adhere to a respective surface of a wall of one of the baffles 40 due to the sudden direction change, thereby separating the liquid particles out from the air.

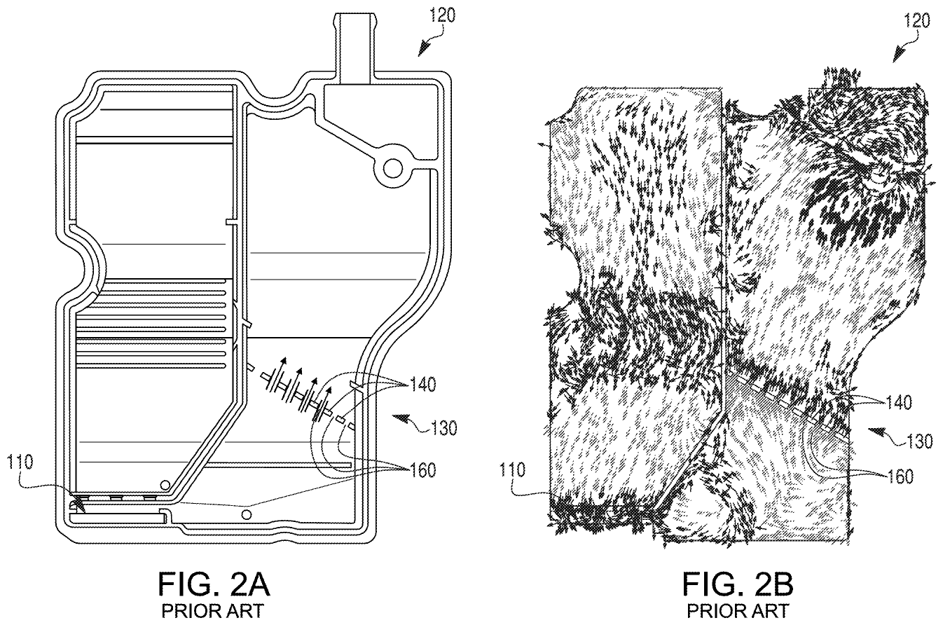

Due to the variable-angle baffle arrangement of the sub-separator 30, the sub-separator 30 also provides the desired downstream flow distribution and distributes the flow more evenly and uniformly on the downstream side of the sub-separator 30, causing the downstream fluid to flow across the width of the housing 22 between the two side walls 24. For example, as shown in the flow model or flow pattern of velocity vectors in FIG. 5B (as compared with the flow model of velocity vectors of the conventional sub-separator 130 shown in FIG. 2B), the sub-separator 30 improves and maintains a desired flow distribution downstream from the sub-separator 30.

In order to create and maintain a particular flow distribution downstream from the sub-separator 30, selected slots 60 of the sub-separator 30 are oriented at different angles relative to each other (as described further herein). The plurality of slots 60 comprises any number of two or more subsets of slots 60 positioned at different angles relative each other. In particular, the plurality of slots 60 comprises a first subset 60a of slots 60 and a second subset 60b of slots 60 (and optionally additional subsets of slots, such as a third subset 60c of slots 60, etc.). The first subset 60a of the plurality of slots 60 are positioned or inclined at a different angle than the second subset 60b of the plurality of slots 60 (such that all of the slots 60 are not parallel to each other along the fluid flow direction). The third subset 60c of slots 60 are also positioned or inclined a different angle than the first subset 60a and the second subset 60b of slots 60. Each subset of the plurality of slots 60 may have any number of slots 60 (and as few as one single slot 60 each). Accordingly, upstream fluid flow (which may have a non-uniform distribution) entering into the sub-separator 30 through the upstream side strikes on the baffles 40 and flows through the slots 60, which divides the fluid flow uniformly across the entire sub-separator 30. The angle of each of the individual slots 60 guides particular portions of the fluid flow into specific different directions from each other (according to the downstream shape of the housing 22, for example), which creates and helps maintain a desired downstream flow distribution on the downstream side of the sub-separator 30 (based on the required downstream geometry or outlet location, for example), thereby utilizing the available flow volume more effectively than conventional sub-separators.

Additionally, due to the configuration of the sub-separator 30, the sub-separator 30 helps drain separated liquid (e.g., oil) and distributes the fluid well across the area available for flow within the air-liquid separation assembly 20. By altering the downstream flow field of the fluid, the sub-separator 30 can reduce the flow velocity (and keep the air flow velocity relatively low) on the downstream side of the plurality of baffles 40. By reducing the flow velocity, the amount of carryover of regenerated liquid particles and liquid re-entrainment is reduced (or prevented). In particular, this configuration of the baffles 40 helps any separated or regenerated liquid particles to change their trajectory and hence prevents re-entraining and carrying-over to the outlet 23. Furthermore, the pressure drop is also reduced (in particular compared to conventional sub-separator 130 shown in FIG. 4).

FIGS. 6A-6B show one embodiment of the sub-separator 30 positioned within an air-liquid separation assembly 20 in which sub-separator 30 creates a desired flow distribution. Location 11 (labeled in FIG. 6A) shows the area where the main separator 10 would be located in an assembled state. FIG. 6C shows a flow model of velocity vectors of fluid flowing through the air-liquid separation assembly 20, and FIG. 7 shows a flow model of velocity vectors of fluid flowing through a conventional air-liquid separation assembly 120 (with a conventional sub-separator 130). The trajectory arrows 12 and 112 show the approximate trajectory of the regenerated liquid particle from the baffles 40 and the conventional baffles 140, respectively. As demonstrated by the respective lengths of the trajectory arrows 12 and 112, the liquid particles in the air-liquid separation assembly 20 have to travel more distance (than the liquid particles in the conventional air-liquid separation assembly 120) on the downstream side of the sub-separator 30. Therefore, the chances of the liquid particle settling on the bottom wall (i.e., one of the main walls 26) are increased due to gravitational forces compared to the liquid particles within the conventional air-liquid separation assembly 120.

### Plurality of Baffles

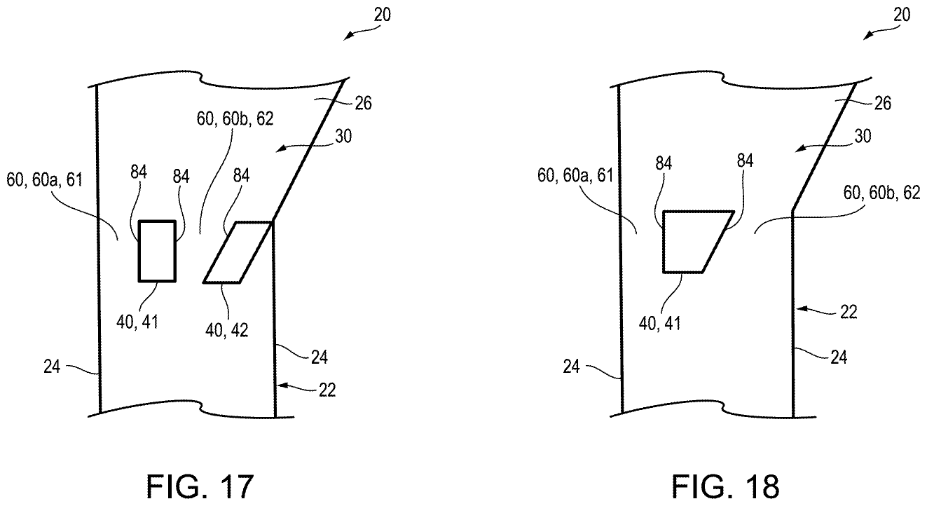

As shown in FIGS. 8-14 and 16-18, the plurality of baffles 40 are positioned in a single row (which may be straight, angled, or curved, as described further herein) between the two side walls 24 of the housing 22. The plurality of baffles 40 are spaced apart from each other in the width direction of the baffles 40 between the side walls 24 to form the plurality of slots 60, where each of the slots 60 is positioned between two baffles 40 (i.e., between a side wall 84 of the first baffle 41 and a side wall 84 of the second baffle 42), as shown in FIG. 8, or between a baffle 40 (e.g., a side wall 84 of the first baffle 41) and a portion (e.g., a side wall 24) of the housing 22, as shown in FIGS. 17-18. Accordingly, the plurality of baffles 40 with the plurality of slots 60 extend between and are alternately positioned or arranged next to each other (with each of the slots 60 positioned between the baffles 40) in the single row between the two side walls 24 of the housing 22. The single row may have a louvered arrangement (in which the baffles 40 overlap each other across the width of the housing 22 and in the direction of fluid flow) according to one embodiment. Additionally, each of the baffles 40 extends completely along its height between the inner surfaces of the two main walls 26 of the housing 22 such that the fluid cannot flow above or below the baffles 40 between the two main walls 26. According to another embodiment, the baffles 40 may extend only partially between the two main walls 26. For example, the baffles 40 may extend directly from one of the main walls 26 (e.g., the top wall) to an area between the two main walls 26, such that there is a gap between the end of the baffle and the other main wall 26 (e.g., the bottom wall). Accordingly, the fluid may flow above or below the baffles 40 (i.e., between the baffles 40 and one of the two main walls 26) in such an arrangement.

With the above-described arrangement for the plurality of baffles 40, the plurality of slots 60 (which comprises at least two slots 60) are positioned next to each other (through a baffle 40) along the width of the housing 22, in a direction substantially perpendicular to the direction of fluid flow of fluid through the housing 22 (e.g., from the inlet 21 to the outlet 23). Accordingly, fluid flow through the plurality of slots 60 occurs at the same time along the width of the housing 22 through each of the slots 60 (rather than the slots 60 being positioned in series). Each portion of fluid is forced to flow in and flows through only one of the plurality of slots 60 (between two of the baffles 40 or between a baffle 40 and a side wall 24 of the housing 22) in order to bypass the baffles 40 as the fluid flows from the inlet 21 to the outlet 23. The fluid cannot bypass the plurality of slots 60 (or, according to one embodiment, the plurality of slots 60 or the gap formed between the top or bottom end of the baffles 40 and one of the main walls 26) in order to flow from the inlet 21 to the outlet 23. Therefore, all of the fluid flowing through the air-liquid separation assembly 20 to the outlet 23 has to flow through one of the plurality of slots 60 (or the gap between the baffle 40 and one of the main walls 26). As described further herein, however, the particular angles of each of the slots 60 are not all parallel to each other (although the slots 60 are not positioned in series with each other).

The variable-angle baffle arrangement comprises a plurality of baffles 40 aligned in a single row comprising X number of baffles 40 defining Y number of the plurality of slots 60. In particular, the plurality of baffles 40 is an X number of baffles 40, and the plurality of slots is a Y number of slots 60. Depending on the arrangement of the end-most baffles of the plurality of the baffles 40 relative to the side walls 24 of the housing 22, the Y number of the plurality of slots 60 may vary. The two end-most baffles 40 refer to the baffles 40 on opposite ends of the single row of the plurality of baffles 40. Relative to the rest of the plurality of baffles 40, the end-most baffles 40 are closest to the two opposite side walls 24 of the housing 22 that the single row of the plurality of baffles 40 extends between (along a direction substantially perpendicular to the direction of fluid flow through the housing 22). The end-most baffles 40 either directly abut or are spaced apart from the respective side wall 24 of the housing 22. According to the various embodiments, the Y number of the plurality of slots is equal to one of X−1, X, or X+1 (where X is the number of baffles 40).

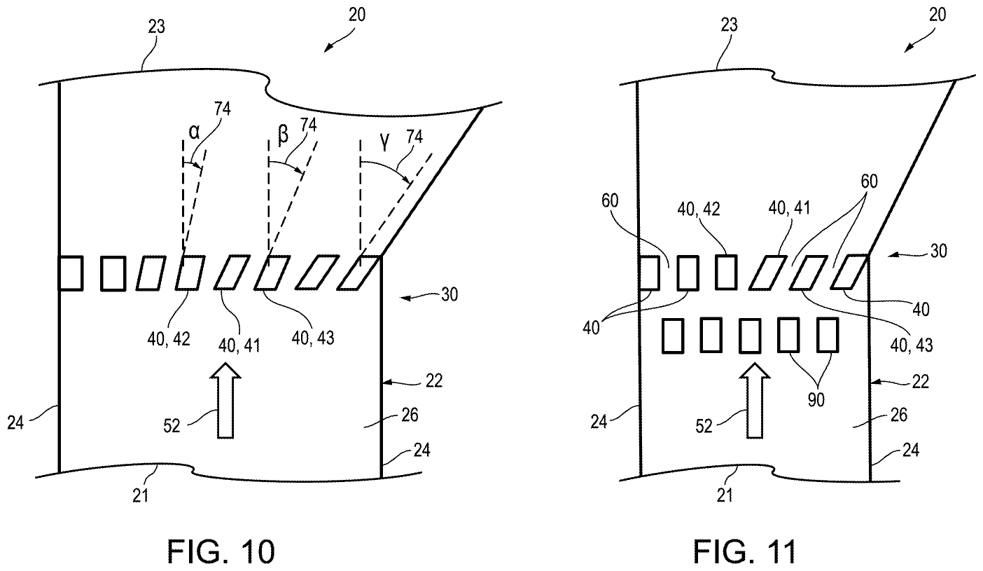

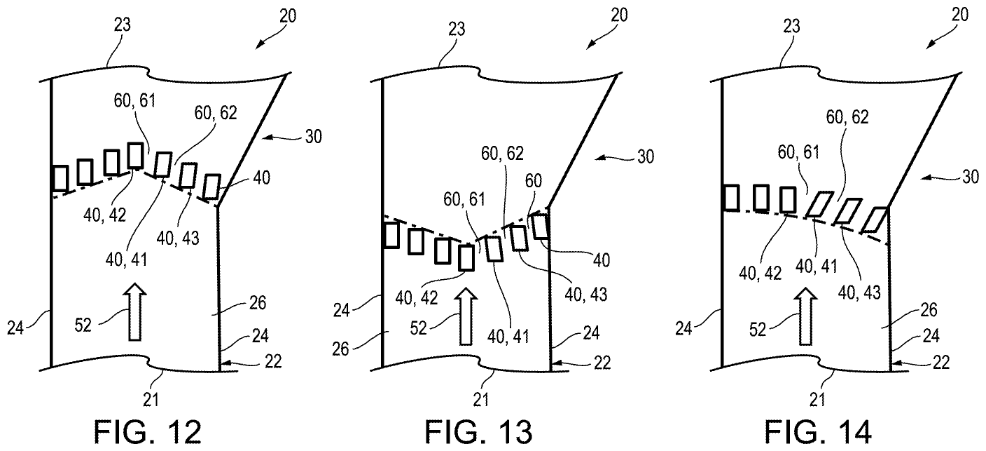

For example, according to one embodiment, both of the two end-most baffles 40 of the plurality of baffles 40 are positioned directly along and directly abut the two side walls 24 of the housing 22, respectively, such that there are no slots between the two end-most baffles 40 and the side walls 24 and fluid cannot flow between the two end-most baffles 40 and the two side walls 24 of the housing 22 (as shown in FIG. 8). According to this embodiment, the Y number of the plurality of slots 60 is equal to X−1, where the X number is greater than or equal to three (in order to form at least two slots 60). In this arrangement, each one of the plurality of slots 60 is positioned between two of the plurality of baffles 40. For example, the sub-separator 30 may comprise six baffles 40 defining five slots 60 (as shown in FIGS. 8-9, 11, and 14), seven baffles 40 defining six slots 60 (as shown in FIGS. 12-13), or eight baffles 40 defining seven slots 60 (as shown in FIGS. 5A, 10), fourteen baffles 40 defining thirteen slots 60 (as shown in FIGS. 6A-6B), etc.

According to another embodiment as shown in FIG. 17, only one of the two end-most baffles 40 of the plurality of baffles 40 is positioned directly along and directly abuts one of the two side walls 24 of the housing 22 (such that there is no slot between the one of the two end-most baffles 40 and the side walls 24 and fluid cannot flow between the one of the two end-most baffles 40 and the corresponding one of the two side walls 24 of the housing 22). The other of the two end-most baffles 40, however, is spaced apart from the other of the two housing side walls 24 such that one of the plurality of slots 60 is defined by a side wall 84 of the other of the two end-most baffles 40 and the other of the two housing side walls 24 (and fluid can flow between the other of the two end-most baffles 40 and the other of the two housing side walls 24). In such an arrangement, there is only one slot between an end-most baffle 40 and its side wall 24. According to this embodiment, the Y number of the plurality of slots 60 is equal to X, where the X number is greater than or equal to two (in order to form at least two slots 60).

According to yet another embodiment as shown in FIG. 18, both of the two end-most baffles 40 of the plurality of baffles 40 are spaced apart from the respective two housing side walls 24 such that two slots 60 are each defined by and positioned between a side wall 84 of one of the end-most baffles 40 and their respective side walls 24 (and fluid can flow between each of the two end-most baffles 40 and each of the two housing side walls 24). In such an arrangement, the Y number of the plurality of slots 60 is equal to X+1, where the X number is greater than or equal to one (in order to form at least two slots 60).

As shown in FIG. 8, the plurality of slots 60 comprises at least a first subset 60a of slots 60 and a second subset 60b of slots 60 (and optionally other subsets of slots 60, such as a third subset 60c of slots 60), where each subset of slots 60 comprises any number of slots 60 (and as few as one single slot 60 as shown in FIGS. 17-18). Each of the subsets 60a, 60b, 60c of slots 60 extend at different angles such that fluid flows through each of the subsets 60a, 60b, 60c of slots at different angles. Furthermore, each of the slots 60 within each subset of slots 60 (e.g., within the first subset 60a of slots 60, the second subset 60b of slots 60, and the third subset 60c of slots 60) extend at the same angle to each other. Accordingly, the plurality of baffles 40 comprises at least one baffle 40 defining one side of at least two different slots 60 (i.e., a first slot of a first subset 60a of slots 60 and a second slot a second subset 60b of slots 60). In particular, the at least one baffle 40 comprises a first side wall 84 and a second side wall 84 (that are opposite each other). The first side wall 84 defines one side of a first slot 61 within a first subset of slots 60a, and the second side wall 84 defines one side of a second slot 62 within the second subset of slots 60b (as shown, for example, in FIG. 8).

Although the plurality of baffles 40 may comprise more than one baffle 40 (defining more than two slots 60 in a single row), at least two of the slots 60 (in particular a first slot 61 of the first subset 60a of slots 60 and a second slot 62 of the second subset 60b of slots 60) defined by the plurality of baffles 40 (or by the single baffle 40) are positioned and extend at different angles from each other. In other words, the longitudinal axis at least one of the slots 60 of the first subset 60a of slots 60 (in the direction of flow through the respective slot 60) extends at a non-parallel angle to the longitudinal axis of at least one other slot 60 of the second subset 60b of slots 60.

Depending on the position of the baffles 40 relative to the side walls 24 of the housing 22 (i.e., whether the end-most baffles 40 directly abut or are spaced apart from its respective side wall 24), each of the plurality of slots 60 may be positioned either between two adjacent baffles 40 or between a side wall 84 of a baffle 40 and a side wall 24 of the housing 22. In each arrangement, however, the first slot 61 and the second slot 62 are positioned directly next to and on opposite sides (i.e., on opposite side walls 84) of the first baffle 41 (as shown in FIG. 8, for example). According to one embodiment as shown in FIG. 8 (in view of FIG. 9), all of the slots 60 are positioned directly between the respective side walls 84 of two adjacent baffles 40 (since the end-most baffles 40 are positioned next to and directly abut a side wall 24 of the housing 22 such that there is no slot between the end-most baffle 40 and the side wall 24 of the housing 22, as described further herein). In this arrangement, the plurality of baffles 40 comprises at least a first baffle 41, a second baffle 42, and a third baffle 43 defining a first slot 61 of the first subset 60a of slots 60 and a second slot 62 of the second subset 60b of slots 60. The first baffle 41 is positioned in between the second baffle 42 and the third baffle 43 along the width direction of the housing 22 between the side walls 24. One side wall 84 of the first baffle 41 is directly next to (and directly opposes) a side wall 84 of the second baffle 42 (with a single slot (i.e., the first slot 61) in between, but with no other baffles or other components in between). The other side wall 84 of the first baffle 41 is directly next to (and directly opposes) a side wall of the third baffle 43 (with a single slot (i.e., the second slot 62) in between, but with no other baffles in between).

As shown in FIGS. 8-14, the first baffle 41, the second baffle 42, and the third baffle 43 may be positioned anywhere along the single row of the plurality of baffles 40 (e.g., at one side portion or in a middle portion of the single row). For example only, as shown in FIG. 8, the first baffle 41 may be positioned third in the single row of baffles 40 to one of the side walls 24. Accordingly, the second baffle 42 is positioned second and the third baffle 43 is positioned fourth in the single row of baffles 40 to the one of the side walls 24.

As further shown in FIG. 8 (in view of FIG. 9), a (first) side wall 84 of the first baffle 41 and a side wall 84 of the second baffle 42 define the first slot 61 (and the first slot 61 is positioned directly in between the first baffle 41 and the second baffle 42). Additionally, the other (second) side wall 84 of the first baffle 41 and a side wall 84 of the third baffle 43 define the second slot 62 (and the second slot 62 is positioned directly in between the second baffle 42 and the third baffle 43).

However, in other embodiments, at least one of the end-most baffles 40 (such as the first baffle 41) may be directly next to, but spaced apart from, (with no other baffles in between) one of the side walls 24 of the housing 22, thereby defining a single slot 60 (i.e., the first slot 61) between the first side wall 84 of the first baffle 41 and the housing side wall 24 (as shown in FIG. 17). With this arrangement, the sub-separator 30 comprises two or more baffles 40 (i.e., the first baffle 41 and the second baffle 42) to define two or more slots 60, with the second baffle 42 positioned between the other second side wall 84 of the first baffle 41 and the other housing side wall 24 (the second baffle 42 may either directly abut or be spaced apart from the other side wall 24 of the housing 22). In this arrangement, the first side wall 84 of the first baffle 41 and a side wall 24 of the housing 22 define the first slot 61 (and the first slot 61 is positioned directly in between the first side wall 84 of the first baffle 41 and the side wall 24 of the housing 22). The other second side wall 84 of the first baffle 41 and the side wall 84 of the second baffle 42 define the second slot 62 (and the second slot 62 is positioned directly in between the second side wall 84 of the first baffle 41 and the side wall 84 of the second baffle 42).

Although multiple baffles 40 are shown, it is understood that the sub-separator 30 may only comprise one baffle 40 (i.e., the first baffle 41) that is spaced apart from both opposite side walls 24 of the housing 22 (i.e., a first housing side wall 24 and a second housing side wall 24) and thereby defines the plurality of slots 60 (which comprises only two slots: the first slot 61 and the second slot 62) with two portions of the housing 22 (i.e., the two housing side walls 24) (as shown in FIG. 18). In particular, a first side wall 84 of the first (one) baffle 41 and a first side wall 24 of the housing 22 define the first slot 61 (and the first slot 61 is positioned directly in between the first side wall 84 of the first baffle 41 and the first side wall 24 of the housing 22). The other (second) side wall 84 of the first (one) baffle 41 and the other (second) side wall 24 of the housing 22 define the second slot 62 (and the second slot 62 is positioned directly in between the second side wall 84 of the first baffle 41 and the other second side wall 24 of the housing 22).

In each arrangement, the first slot 61 (which is the first subset 60a of slots 60) and the second slot 62 (which is the second subset 60b of slots 60) extend at different angles (see, for example, FIG. 8) from each other such that respective portions of fluid flows at the same time through the first slot 61 and the second slot 62 at different angles from each other at the same distance lengthwise along the fluid flow direction. As shown, as the slots 60 are positioned next to each other along the width of the housing 22 and at least partially overlap each other in the width direction of the housing 22, different portions of the fluid flow in parallel (and at the same time) through different slots (i.e., the first slot 61 and the second slot 62) and each portion of the fluid flows through only one of the two slots 60.

As shown in FIG. 8, the fluid (as an air-liquid mixture) flows into the sub-separator 30 in an upstream flow direction 52. The fluid subsequently flows through and out of the sub-separator 30 (through the plurality of slots 60) in at least two different downstream flow directions 54 (corresponding to at least two slots 60 positioned at different angles from each other (e.g., a first downstream direction 55 through the first slot 61 and a second downstream direction 57 through the second slot 62)). For example, the downstream flow direction 54 of fluid flowing through the first slot 61 (that is in the first downstream direction 55) is different than the downstream flow direction 54 of fluid flowing through the second slot 62 (that is in the second downstream direction 57). One of the downstream flow directions 54 may optionally be the same direction as the upstream flow direction 52.

As shown in FIG. 8, the plurality of baffles 40 may comprise any number of baffles 40, including the first baffle 41, the second baffle 42, the third baffle 43, the fourth baffle 44, and any number of additional baffles 40, each defining additional slots 60 with other baffles 40 or the housing side wall 24. The additional slots 60 (and their respective downstream flow directions 54, such as a third downstream flow direction 59) may extend at approximately the same or different angles from each other and from the first slot 61 and the second slot 62 (and the first downstream flow direction 55 and the second downstream flow direction 57, respectively). However, at least two of the slots 60 extend at a different angle from each other.

According to one embodiment shown in FIG. 8, the plurality of baffles 40 may also comprise a fourth baffle 44 (where the third baffle 43 is positioned in between the second baffle 42 and the fourth baffle 44). Accordingly, the third baffle 43 and the fourth baffle 44 define a third slot 63 of the plurality of slots 60 (and the third slot 63 is positioned directly in between the third baffle 43 and the fourth baffle 44). The third slot 63 is a part of a third subset 60c of slots 60 and may also extend at a different angle from the second slot 62 (and the first slot 61) and at least partially overlap the second slot 62 in the width direction of the housing 22 such that fluid flows at the same time through the first slot 61, the second slot 62, and the third slot 63 and at different angles from each other. In particular, the downstream flow direction 54 of fluid flowing through the third slot 63 is in a third downstream direction 59 that is different than the first downstream direction 55 and the second downstream direction 57. Alternatively, however, it is understood that the third slot 63 may extend at approximately the same angle as the second slot 62 (and therefore be a part of the second subset of slots 60) according to another embodiment. Furthermore, the plurality of baffles 40 may comprise any number of baffles 40 above three baffles.

As shown in FIG. 9, each of the sides of the baffles 40 has a particular orientation (in particular relative to the side walls 24) and size. Each of the baffles 40 has an upstream end 82, a downstream end 86, and two side walls 84 (i.e., a first side wall 84 and a second side wall 84 that are opposite each other) extending between the upstream end 82 and the downstream end 86 along the direction of fluid flow and along the length of the corresponding slot 60. As the fluid flows from the inlet 21 to the outlet 23 of the housing 22, the fluid first hits (and/or flows past) the upstream end 82, flows through the slot 60 (flowing along the length of two side walls 84 of adjacent baffles 40 (and along one of the two side walls 84 of one baffle 40)), and then flows past the downstream end 86. The first side wall 84 and the second side wall 84 of one baffle 40 may be at the same or different angles relative to each other (i.e., parallel or not parallel to each other) in order to form the respective slot angles through the slots 60 on opposite sides of the baffle 40. Furthermore, the respective side walls 84 of two adjacent baffles 40 (defining a slot 60) may be at the same or different angles (i.e., parallel or non-parallel) relative to each other depending on the desired slot angle.

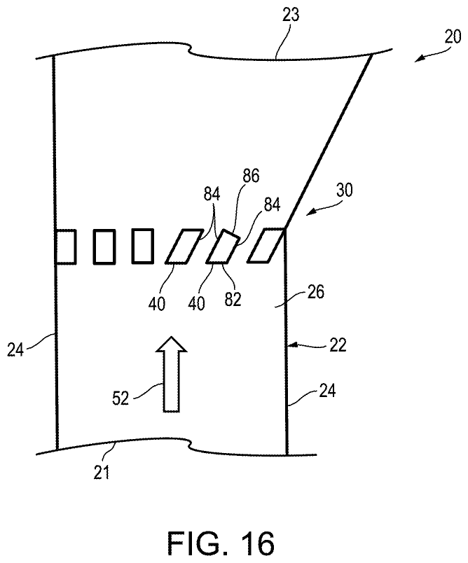

The main baffle angle 72 (labeled in FIG. 9) is the angle between the downstream end 86 and one of the side walls 24 (e.g., a CV internal wall). According to some embodiments, the main baffle angle 72 may range between approximately 45° to 135°. However, it is understood that the main baffle angle 72 may be at a different angle. For example, as shown in FIG. 16, the downstream end 86 of at least one of the baffles 40 may be angled upstream, causing the main baffle angle 72 to be at an angle outside of this range. The baffle side angle 74 (labeled in FIGS. 9-10) is the angle of a side wall 84 of a baffle 40 with respect to one of the side walls 24 (e.g., a CV internal wall, in particular a housing side wall 24 upstream from the sub-separator 30). The baffle side angle 74 of two adjacent side walls 84 (facing each other) of two adjacent baffles 40 determines or defines the slot angle of the slot 60. The slot angle is the overall angle of the slot 60 based on the baffle side angles 74 of the two adjacent baffles 40 and thus the direction that the fluid flows in through that particular slot 60. The baffle side angle 74 may range between approximately −45° to 45°. According to some embodiments, the ratio of the length L of the baffle 40 (i.e., the distance between the upstream end 82 and the downstream end 86 along a side wall 84) to the width W of the baffle 40 (i.e., the distance between the two side walls 84 of a baffle 40 along the upstream end 82 or the downstream end 86) may be approximately 0.5 to 5 (and preferably approximately 0.5 to 1.5).

According to one embodiment as shown in FIG. 10, the respective slot angles within each (and all) of the plurality of slots 60 within the sub-separator 30 are different or varied from each other. The slots 60 may be progressively and continuously more and more angled (i.e., continuously varying slot angles) along the length of the single row of baffles 40. Accordingly, a slot angle of each of the plurality of slots 60 increases at each of the plurality of slots 60 along the length of the single row of the plurality of baffles 40. For example, one of the baffle side angles 74 at an angle of α is less than another baffle side angle 74 at an angle of ≈, which is less than another baffle side angle 74 at an angle of γ, where each of these baffle side angles 74 are arranged sequentially along the single row of baffles 40. The slot angles vary according to the baffle side angles 74.

According to another embodiment as shown in FIG. 11 (as well as FIGS. 6A-6B), the sub-separator 30 further comprises a second plurality of baffles 90 arranged in a second row and are staggered or stacked with each of the first plurality of baffles 40. The second plurality of baffles 90 is positioned upstream or downstream from the first plurality of baffles 40. Accordingly, each of second plurality of the baffles 90 are at least partially offset from the first plurality of baffles 40 along the direction of flow and are at least partially aligned with and directly upstream (or, alternatively, downstream) of each of the slots 60 of the first plurality of baffles 40. The slots defined by the second plurality of baffles 90 may be at the same angle or different angles relative to each other.

The single row of the plurality of baffles 40 refers to the plurality of baffles 40 being positioned relative to each other between the housing side walls 24 such that each portion of fluid has to flow between only one of the plurality of slots 60. The single row, however, may have a variety of different configurations. For example, the single row of the plurality of baffles 40 can be arranged in one approximately straight line that is substantially perpendicular to the side walls 24 (as shown in FIGS. 8-11) or that is angled (at an oblique angle) relative to the side walls 24 (as shown in FIG. 5A). Alternatively, the single row of the plurality of baffles 40 can be arranged in a v-shape (as shown in FIG. 12), in an inverted v-shape (as shown in FIG. 13), in a w-shape, in an inverted w-shape, or curved or arced (as shown in FIG. 14). As shown in FIG. 14, the single row of the plurality of baffles 40 is curved or arced between the two housing side walls 24.

In the v-shape, the inverted v-shape, or the w-shape, the single row of the plurality of baffles 40 extends in at least two approximately straight lines that connect with each other across the width of the housing 22 and that are at an angle to each other (and may be at oblique angles to the side walls 24 of the housing 22) between the housing side walls 24. In the v-shape (as shown in FIG. 12), the “v” points downstream such that the middle of the single row of baffles 40 is further downstream than the sides of the single row. In the inverted v-shape (as shown in FIG. 13), the “v” points upstream such that the middle of the single row of baffles 40 is further upstream than the sides of the single row. A similar configuration can be done with the w-shape and the inverted w-shape.

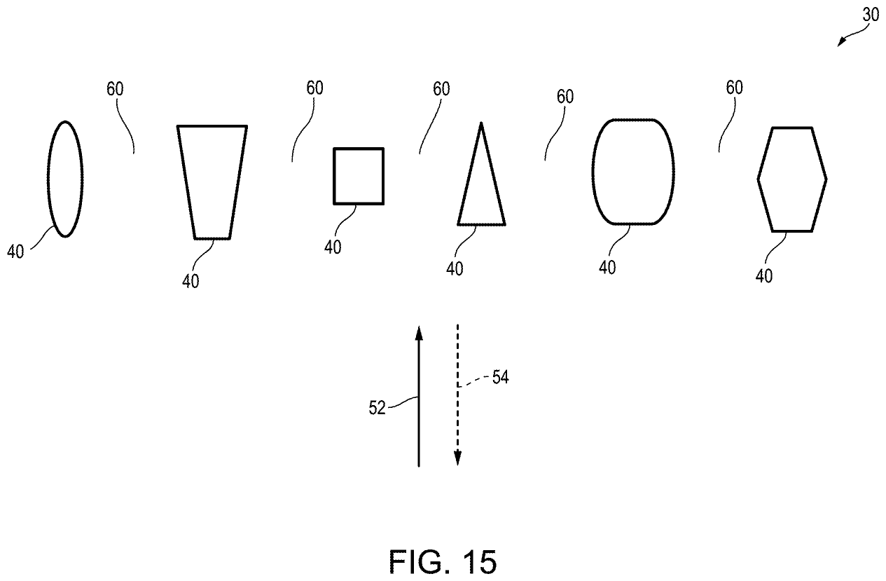

As shown in various figures, the baffles 40 may have a quadrilateral (e.g., rectangle, trapezoid, or parallelogram) shape. However, as shown in FIG. 15, the baffles 40 may have a variety of different shapes, according to the desired configuration. For example, the baffles 40 may have an oval, isosceles trapezoid, square, triangle, rounded rectangle, or hexagon shape. The flow direction may be in either direction, as shown by the upstream flow direction 52 and the alternative downstream flow direction 54 in FIG. 15. The sub-separator 30 may comprise baffles 40 that are a similar shape to each other or a combination of differently shaped baffles 40.

Each of the various embodiments of the plurality of baffles 40 may comprise the various features and components of the other embodiments of the plurality of baffles 40, unless otherwise noted in the description herein.

As utilized herein, the terms “approximately,” “substantially,” and similar terms are intended to have a broad meaning in harmony with the common and accepted usage by those of ordinary skill in the art to which the subject matter of this disclosure pertains. The terms “approximately” and “substantially” as used herein refers to ±5% of the referenced measurement, position, or dimension. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An air-liquid separation assembly for separating air and liquid from an air-liquid mixture, the air-liquid separation assembly comprising:
a housing through which fluid flows;
a main separator positioned within the housing; and
a sub-separator positioned within the housing before or after the main separator and defining a plurality of slots, each of the plurality of slots positioned either between adjacent baffles of the sub-separator or between a baffle of the sub-separator and a portion of the housing,
the plurality of slots positioned next to each other in a direction substantially perpendicular to the direction of fluid flow through the housing such that each portion of the fluid flow flows through only one of the plurality of slots,
the plurality of slots comprising a first subset of slots and a second subset of slots, the second subset of slots extends at a different angle than the first subset of slots such that fluid flows through the first subset of slots and the second subset of slots at different angles,
the sub-separator comprising at least one baffle defining the plurality of slots, the at least one baffle comprising a first side wall and a second side wall opposite the first side wall, the first side wall defining one side of a first slot within the first subset of slots, the second side wall defining one side of a second slot within the second subset of slots.

2. The air-liquid separation assembly of claim 1, wherein respective slot angles within all of the plurality of slots are different from each other.

3. The air-liquid separation assembly of claim 1, wherein each of the slots within the first subset of slots are at the same angle to each other.

4. (canceled)

5. (canceled)

6. The air-liquid separation assembly of claim 1, wherein the first side wall and the second side wall of the at least one baffle are not parallel to each other.

7. The air air-liquid separation assembly of claim 1, wherein the first side wall and the second side wall of the at least one baffle are parallel to each other.

8. The air-liquid separation assembly of claim 1, wherein the sub-separator comprises a plurality of baffles comprising the at least one baffle and defining the plurality of slots, the plurality of baffles positioned next to each other in a single row between two housing side walls of the housing.

9. The air liquid separation assembly of claim 8, wherein a slot angle of each of the plurality of slots increases at each of the plurality of slots along the length of the single row of the plurality of baffles.

10. The air liquid separation assembly of claim 8, wherein the single row of the plurality of baffles is arranged in one approximately straight line that is substantially perpendicular relative to the two housing side walls.

11. The air liquid separation assembly of claim 8, wherein the single row of the plurality of baffles is arranged in one approximately straight line that is at an oblique angle relative to the two housing side walls.

12. The air liquid separation assembly of claim 8, wherein the single row of the plurality of baffles is curved between the two housing side walls.

13. The air liquid separation assembly of claim 8, wherein the single row of the plurality of baffles extends in at least two approximately straight lines that are at an angle to each other between the two housing side walls.

14. The air-liquid separation assembly of claim 8, wherein both of two end-most baffles of the single row of the plurality of baffles directly abut the two housing side walls such that fluid cannot flow between the two end-most baffles and the two housing side walls.

15. The air liquid separation assembly of claim 8, wherein one of two end-most baffles of the single row of the plurality of baffles directly abuts one of the two housing side walls such that fluid cannot flow between the one of the two end-most baffles and the one of the two housing side walls, and
wherein the other of the two end-most baffles of the single row of the plurality of baffles is spaced apart from the other of the two housing side walls such that one of the plurality of slots is defined by a side wall of the other of the two end-most baffles and the other of the two housing side walls.

16. The air liquid separation assembly of claim 8, wherein both of the two end-most baffles of the single row of the plurality of baffles are spaced apart from the two housing side walls such that two of the plurality of slots are each defined by a side wall of one of the two end-most baffles and one of the two housing side walls.

17. The air-liquid separation assembly of claim 8, wherein the plurality of baffles is an X number of baffles and the plurality of slots is a Y number of slots, wherein the Y number of the plurality of slots is equal to X−1.

18. The air-liquid separation assembly of claim 8, wherein the plurality of baffles is an X number of baffles and the plurality of slots is a Y number of slots, wherein the Y number of the plurality of slots is equal to the X number of baffles.

19. The air-liquid separation assembly of claim 8, wherein the plurality of baffles is an X number of baffles and the plurality of slots is a Y number of slots, wherein the Y number of the plurality of slots is equal to X+1.

20. The air-liquid separation assembly of claim 1, wherein the sub-separator comprises a first plurality of baffles comprising the at least one baffle and defining the plurality of slots, and further comprising a second plurality of baffles positioned upstream or downstream from the first plurality of baffles and are staggered with each of the first plurality of baffles.

21. The air-liquid separation assembly of claim 1, wherein the the at least one baffle is the only one baffle and is spaced apart from a first housing side wall and a second housing side wall of the housing and the plurality of slots comprises only the first slot and the second slot, and
wherein the first slot is defined by the first side wall of the one baffle and the first housing side wall and the second slot is defined by the second side wall of the one baffle and the second housing side wall.

22. The air-liquid separation assembly of claim 1, wherein the plurality of slots further comprises a third subset of slots extending at a different angle from the first subset of slots and the second subset of slots.

23. An air-liquid separation assembly for separating air and liquid from an air-liquid mixture, the air-liquid separation assembly comprising:
a housing through which fluid flows; and
a sub-separator positioned within the housing defining a plurality of slots positioned next to each other in a direction substantially perpendicular to the direction of fluid flow through the housing such that each portion of the fluid flow flows through only one of the plurality of slots,
the plurality of slots comprising a first subset of slots and a second subset of slots, the second subset of slots extends at a different angle than the first subset of slots such that fluid flows through the first subset of slots and the second subset of slots at different angles,
the sub-separator comprising at least one baffle defining the plurality of slots,
the at least one baffle comprising a first side wall and a second side wall opposite the first side wall, the first side wall defining one side of a first slot within the first subset of slots, the second side wall defining one side of a second slot within the second subset of slots.

24. (canceled)

25. An air liquid separation assembly for separating air and liquid from an air-liquid mixture, the air-liquid separation assembly comprising:
a housing through which fluid flows;
a main separator positioned within the housing; and
a sub-separator positioned within the housing before or after the main separator and defining a plurality of slots, each of the plurality of slots positioned either between adjacent baffles of the sub-separator or between a baffle of the sub-separator and a portion of the housing,
the plurality of slots positioned next to each other in a direction substantially perpendicular to the direction of fluid flow through the housing such that each portion of the fluid flow flows through only one of the plurality of slots,
the plurality of slots comprising a first subset of slots and a second subset of slots, the second subset of slots extends at a different angle than the first subset of slots such that fluid flows through the first subset of slots and the second subset of slots at different angles,
the sub-separator comprising a plurality of baffles defining the plurality of slots, the plurality of baffles positioned next to each other in a single row between two housing side walls of the housing,
wherein the single row of the plurality of baffles is curved between the two housing side walls.

26. An air liquid separation assembly for separating air and liquid from an air-liquid mixture, the air-liquid separation assembly comprising:
a housing through which fluid flows;
a main separator positioned within the housing; and
a sub-separator positioned within the housing before or after the main separator and defining a plurality of slots, each of the plurality of slots positioned either between adjacent baffles of the sub-separator or between a baffle of the sub-separator and a portion of the housing,
the plurality of slots positioned next to each other in a direction substantially perpendicular to the direction of fluid flow through the housing such that each portion of the fluid flow flows through only one of the plurality of slots,
the plurality of slots comprising a first subset of slots and a second subset of slots, the second subset of slots extends at a different angle than the first subset of slots such that fluid flows through the first subset of slots and the second subset of slots at different angles,
the sub-separator comprising a plurality of baffles defining the plurality of slots, the plurality of baffles positioned next to each other in a single row between two housing side walls of the housing,
wherein the single row of the plurality of baffles extends in at least two approximately straight lines that are at an angle to each other between the two housing side walls.

27. An air liquid separation assembly for separating air and liquid from an air-liquid mixture, the air-liquid separation assembly comprising:
a housing through which fluid flows;
a main separator positioned within the housing; and
a sub-separator positioned within the housing before or after the main separator and defining a plurality of slots, each of the plurality of slots positioned either between adjacent baffles of the sub-separator or between a baffle of the sub-separator and a portion of the housing,
the plurality of slots positioned next to each other in a direction substantially perpendicular to the direction of fluid flow through the housing such that each portion of the fluid flow flows through only one of the plurality of slots,
the plurality of slots comprising a first subset of slots and a second subset of slots, the second subset of slots extends at a different angle than the first subset of slots such that fluid flows through the first subset of slots and the second subset of slots at different angles,
the sub-separator comprising a plurality of baffles defining the plurality of slots, the plurality of baffles positioned next to each other in a single row between two housing side walls of the housing,
wherein one of two end-most baffles of the single row of the plurality of baffles directly abuts one of the two housing side walls such that fluid cannot flow between the one of the two end-most baffles and the one of the two housing side walls, and
wherein the other of the two end-most baffles of the single row of the plurality of baffles is spaced apart from the other of the two housing side walls such that one of the plurality of slots is defined by a side wall of the other of the two end-most baffles and the other of the two housing side walls.

28. An air liquid separation assembly for separating air and liquid from an air-liquid mixture, the air-liquid separation assembly comprising:
a housing through which fluid flows;
a main separator positioned within the housing; and
a sub-separator positioned within the housing before or after the main separator and defining a plurality of slots, each of the plurality of slots positioned either between adjacent baffles of the sub-separator or between a baffle of the sub-separator and a portion of the housing,
the plurality of slots positioned next to each other in a direction substantially perpendicular to the direction of fluid flow through the housing such that each portion of the fluid flow flows through only one of the plurality of slots,
the plurality of slots comprising a first subset of slots and a second subset of slots, the second subset of slots extends at a different angle than the first subset of slots such that fluid flows through the first subset of slots and the second subset of slots at different angles,
the sub-separator comprising a plurality of baffles defining the plurality of slots, the plurality of baffles positioned next to each other in a single row between two housing side walls of the housing,
wherein both of the two end-most baffles of the single row of the plurality of baffles are spaced apart from the two housing side walls such that two of the plurality of slots are each defined by a side wall of one of the two end-most baffles and one of the two housing side walls.
